(19) United States
(12) Patent Application Publication
(10) Pub. No.: US 2003/0097503 A1
(43) Pub. Date: May 22, 2003

(54) PCI compatible bus model for non-PCI compatible bus architectures

(76) Inventor: Jeffrey L. Huckins, Chandler, AZ (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/989,475

(22) Filed: Nov. 19, 2001

(51) Int. Cl. G06F 13/00

(52) U.S. Cl. 710/104

(57) ABSTRACT

A method for a Peripheral Component Interconnect (PCI) compatible bus model for non-PCI compatible bus architectures. The method of one embodiment comprises identifying a hardware controller coupled to a PCI compatible bus, the hardware controller compatible to a PCI bus protocol and to a non-PCI bus protocol. The hardware controller is initialized. A non-PCI compatible bus coupled to the hardware controller is searched for a non-PCI compatible device, the non-PCI compatible device compatible to the non-PCI bus protocol. The non-PCI compatible device is configured. The non-PCI compatible device is recognized as a PCI compatible device coupled to said PCI compatible bus.

### FIELD OF THE INVENTION

The present invention relates generally to the field of microprocessors and computer systems. More particularly, the present invention relates to a method and apparatus for peripheral component interface (PCI) compatible bus model for non-PCI compatible bus architectures.

### BACKGROUND OF THE INVENTION

Computer systems have become increasingly pervasive in our society. In recent years, the price of personal computers (PCs) have rapidly declined. As a result, more and more consumers have been able to take advantage of newer and faster machines. As the speed of the new processors increases, new input/output (I/O) devices are also developed to make use of the greater processing power. An enormous array of peripheral devices are available for every kind of computer in the marketplace. These and other I/O devices are typically connected to a computer system through some type of bus. Whenever a user obtains a new I/O device, the user simply plugs the device into the computer and loads the appropriate device driver to configure the system.

Computer motherboards are generally designed with one or more types of expansion buses having a number physical slots or ports to which a user can connect an I/O device. Examples of the different types of expansion buses fall under different protocols including Industry Standard Architecture (ISA), Peripheral Component Interconnect (PCI) local bus, and Accelerated Graphics Port (AGP). However, each bus protocol come with a unique expansion slot and pin configuration. Different bus types are generally not compatible with each other. Furthermore, a specific hardware controller is needed on the motherboard to handle each type of bus. Thus, even though a large number of peripheral I/O devices exist, a user can only use the ones compatible with whichever bus protocols exist in the computer at issue.

The bus limitations of computer systems also impact the manufacturers of systems and I/O devices. Equipping a computer with the capability to handle each bus protocol is expensive in terms of time and money. Similarly, the marketing and development of peripheral devices wherein each bus type is a line item can severely impact product direction. Thus, computer manufacturers often limit the systems produced to having one or two widely popular types of buses. As a result, device manufacturers respond in kind by designing peripherals mainly for a few specific types of bus protocols. Similarly, the introduction of a new bus type is difficult as the computer system designers do not want to include an unknown bus protocol, device vendors do not want to make products for an unknown bus type, and consumers do not wish to buy items for a bus that may not be widely used. It is simply not cost effective for the manufacturers to attempt to meet the needs of every consumer out there with a unique and incompatible bus protocol.

### BRIEF DESCRIPTION OF THE DRAWINGS

The present invention is illustrated by way of example and not limitations in the figures of the accompanying drawings, in which like references indicate similar elements, and in which:

FIG. 1 is a block diagram of a computer system having a capability to communicate with a non-PCI bus architecture via a PCI compatible bus in accordance with the present invention;

FIG. 2 is a block diagram of one embodiment of a non-PCI compatible bus architecture joined with a PCI compatible bus architecture;

FIG. 3 is a block diagram of another embodiment of a non-PCI compatible bus architecture joined with a PCI compatible bus architecture;

FIG. 4 is a block diagram of the software stack residing in a computer of one embodiment;

FIG. 5 is a flow chart showing one embodiment of a method to initialize a computer to access a non-PCI compatible bus architecture;

FIG. 6A is a flow chart showing one embodiment of a method in accordance with the present invention to communicate with a non-PCI compatible device across a PCI bus; and

FIG. 6B is a flow chart showing one embodiment of a method in accordance with the present invention to receive communications from a non-PCI compatible device across a PCI bus.

### DETAILED DESCRIPTION

A method and apparatus for a PCI compatible bus model for non-PCI compatible bus architectures is disclosed. The embodiments described herein are described in the context of a microprocessor, but are not so limited. Although the following embodiments are described with reference to a computer system and the PCI bus protocol, other embodiments are applicable to other computing devices and other types of bus protocols. The same techniques and teachings of the present invention can easily be applied to other types of machines or systems that can benefit from connecting together incompatible bus architectures.

In the following description, for purposes of explanation, numerous specific details are set forth in order to provide a thorough understanding of the present invention. One of ordinary skill in the art, however, will appreciate that these specific details are not necessary in order to practice the present invention. In other instances, well known electrical structures and circuits have not been set forth in particular detail in order to not necessarily obscure the present invention.

As technology advances and new products emerge in the marketplace, many users have a desire to upgrade their existing computers and associated hardware. Most of these upgrades or replacements are associated with peripheral I/O hardware devices such as video cards, sound cards, network controllers, game controllers, disk drives, etc. One popular bus protocol found in many computer systems is the PCI bus protocol. System manufacturers generally include a couple of PCI expansion slots on the motherboard of every computer. As a result, peripheral device vendors design a large number of PCI compatible type of I/O devices to capitalize on the readily available market. However, improvements in bus technology are not as easily taken advantaged of. In order to incorporated a new bus protocol into a computer system, a system manufacturer has to spend enormous amounts of time and money to design the new protocol and its necessary components into the board. Because bus protocols are usually not compatible and have different connectors, a peripheral device adhering to a first protocol is not easily interchangeable and cannot be used with a second protocol.

New bus architectures are continually being developed in order to improve the performance and utility of computer platforms. However, it is often necessary to first integrate these new buses into the present platform via existing or legacy bus interfaces until native support can be provided for the operating systems that run on the platform. Thus a system designer may wish to piggyback off an existing bus in the computer system in order to introduce a new bus protocol. Furthermore, a designer can easily incorporate a proprietary bus into a system with an embodiment of the present invention as long as end is PCI compatible. Embodiments of the present invention allow for the integration of a non-PCI compatible bus architecture into a system through a PCI compatible bus. Currently, the PCI bus is the predominant I/O bus having the most advanced plug-and-play (PnP) and power management capabilities. In order to integrate a new bus interface or interconnect bus into the PC platform in accordance with the present invention, a designer can use a system PCI bus to connect non-PCI compatible types of I/O devices to the computer. Because the PCI and non-PCI protocols are incompatible, the incompatible characteristics of the new bus have to be hidden from the system in order to masquerade the non-PCI bus and its new peripherals as a PCI bus and PCI type of devices.

Presently, support for the integration or interconnection of non-PCI buses and devices does not exist. Furthermore, no standard bus integration model offers PCI compatibility. By using embodiments of the present invention, manufacturers can significantly reduce the time to market for new types of buses and I/O devices. Enhanced buses and related architectures can be introduced and delivered to the marketplace sooner than if a vendor needed to design the new bus into systems. The bus model of embodiments of the present invention allow companies to easily provide the functionality of different types of presently unsupported new buses to support mobile communications, advance multimedia functionalities, and other value enhancing features.

Embodiments in accordance of the present invention as described below include a hardware controller or bus bridge to perform PCI to non-PCI and non-PCI to PCI translations for the PCI I/O commands/data to and from the host computer. The hardware controller masks the non-PCI bus architecture and topology from the host computer system in order to leverage the native initialization and configuration support that already exists for an industry standard bus and interface like PCI. To accomplish this, the hardware controllers will expose themselves to the system as a PCI-to-PCI (P2P) bridge on which PCI compatible devices are connected. By masquerading as a P2P bridge, the hardware controller is offered the opportunity to function as a proxy to its downstream non-PCI compatible devices. The I/O devices (communication front end devices or CFE) can be integrated into the system by the hardware controller as PCI compatible devices.

In one embodiment of the bus model, a hardware controller is a “traffic director” for downstream bus controller devices and non-PCI CFE devices. As the traffic director, the hardware controller acts as the target of upstream bus transactions from an I/O device to the host and as the initiator of new non-PCI compatible bus transactions from the host. PCI commands and messages from the host have to be translated by a hardware controller into non-PCI commands and messages before being delivered downstream to a non-PCI device. Similarly, a hardware controller has to translate the upstream non-PCI commands into PCI commands to the host. As a result, embodiments of the present invention also manage a mapping between the PCI device identification (ID) and the non-PCI device ID in order to properly route communication traffic to and from the PCI bus.

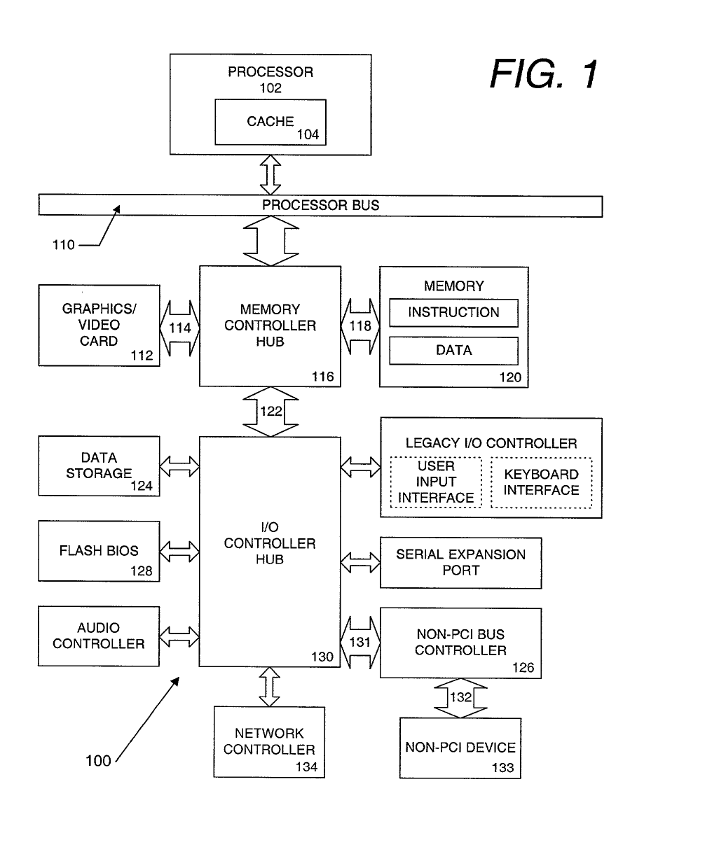

Referring now to FIG. 1, an exemplary computer system 100 is shown. System 100 is representative of processing systems based on the PENTIUM® III, PENTIUM® 4, and/or Itanium™ microprocessors available from Intel Corporation of Santa Clara, Calif., although other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems and graphical user interfaces, UNIX and Linux for example, may also be used. Thus, the present invention is not limited to any specific combination of hardware circuitry and software.

The present enhancement is not limited to computer systems. Alternative embodiments of the present invention can be used in other devices such as embedded applications. Embedded systems can include a microcontroller, a digital signal processor (DSP), system on a chip, network computers (NetPC), set-top boxes, network hubs, wide area network (WAN) switches, or any other system which uses a PCI bus protocol and can connect to devices via a PCI bus.

FIG. 1 is a block diagram of a computer system 100 having the capability to communicate with a non-PCI bus architecture via a PCI compatible bus in accordance with the present invention. The present embodiment is described in the context of a single processor desktop or server system, but alternative embodiments can be included in a multiprocessor system. System 100 is an example of a hub architecture. The computer system 100 includes a processor 102 to process data signals. The processor 102 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that transmits data signals between the processor 102 and other components in the system 100. The elements of system 100 perform their conventional functions well known in the art.

System 100 includes a memory 120. Memory 120 can be a dynamic random access memory (DRAM) device, a static random access memory (SRAM) device, flash memory device, or other memory device. Memory 120 can store instructions and/or data represented by data signals that can be executed by the processors 102. An internal cache memory 104 can reside inside the processor 102 to store recently used data signals from memory 120. Alternatively, in another embodiment, the cache memory can reside external to the processor 102.

A system logic chip 116 is coupled to the processor bus 110 and memory 120. The system logic chip 116 in the illustrated embodiment is a memory controller hub (MCH). The processor 102 communicates to the MCH 116 via a processor bus 110. The MCH 116 provides a high bandwidth memory path 118 to memory 120 for instruction and data storage and for storage of graphics commands, data and textures. The MCH 116 is to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102. The PCI protocol is commonly associated with a type of the local I/O bus. Some examples are the audio controller, firmware hub (flash BIOS) 128, data storage 124, legacy I/O controller containing user input and keyboard interfaces, a serial expansion port such as Universal Serial Bus (USB), wireless transceivers, and a network controller 134. The data storage device 124 can comprise a hard disk drive, a floppy disk drive, a CD-ROM device, a flash memory device, or other mass storage device.

For the embodiment of a computing system in FIG. 1, a non-PCI bus controller 126 is also coupled on a PCI bus 131 to the ICH 130. The non-PCI bus controller 126 is capable of receiving and transmitting signals to and from the system 100 on the PCI bus 131. The non-PCI bus controller 126 is also physically and electrically compatible to the PCI bus protocol in order to connect to the PCI bus 131. This non-PCI bus controller 126 can also be referred to as a bus bridge. Control of this non-PCI bus controller 126 resides with software located in the controller logic and memory 120. Also coupled to the non-PCI bus controller 126 is a non-PCI device 133. This non-PCI device 133 is coupled on a bus 132 having a protocol different than the PCI protocol. Thus the non-PCI device 133 can indirectly interact with the rest of the system 100 through the PCI bus 131, even though the non-PCI device is not designed to operate with the PCI protocol. Processor 102 can execute instructions from memory 120 that cause the processor 102 to send data to and request from the non-PCI device 133. Furthermore, the non-PCI device 133 may be able to interact with other system components including the audio controller, network controller 134, and I/O controller as needed. The operating system and device driver software can also interface with the non-PCI bus controller 126 and a non-PCI device 133. The bus bridge 126 enables the computer system 100 to communicate with a non-PCI device 133 through a PCI bus 131. Although the example of FIG. 1 shows the presence of one non-PCI device 126, a multiple of non-PCI devices can be coupled to the non-PCI bus bridge 126 depending on the particular implementation. Furthermore in some embodiments, the non-PCI devices may all be directly attached to the non-PCI bus controller 126 itself or the non-PCI devices may be connected together in a daisy chain.

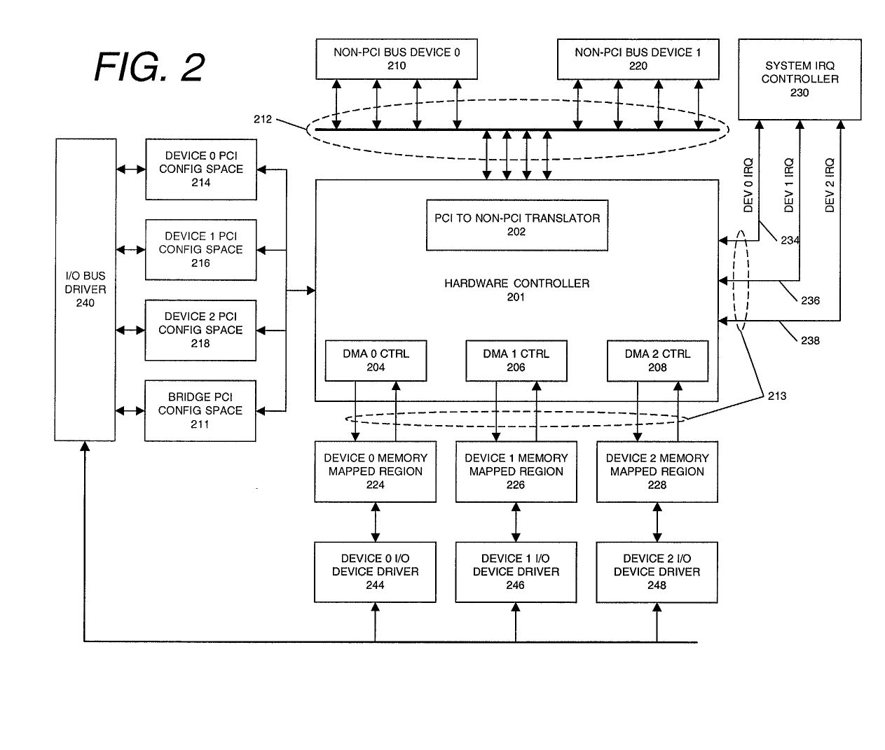

FIG. 2 is a block diagram of one embodiment of a non-PCI compatible bus architecture joined with a PCI compatible bus architecture. For this embodiment, the hardware controller 201 physically resides on the system motherboard. In an alternative embodiment, the hardware controller may be part of a plug-in board or expansion card that slides into a PCI expansion slot on the motherboard. The hardware controller 201 may also be referred to as a bus bridge as the hardware controller 201 functions as a bridge to communications between a first bus 212 compatible with the PCI protocol and a second bus 213 having a non-PCI compatible protocol. Presently, support for the integration or interconnection of can also be referred to a “PCI to non-PCI bus bridge”. But the system itself may view the hardware controller 201 as a P2P bridge. A PCI to non-PCI translator 202 is included in the hardware controller 201. This translator 202 operates to translate data, commands, interrupts, and other information between the PCI and non-PCI bus protocols. For this embodiment, the translator 202 is implemented in logic circuits within the hardware controller 201. The translator 201 of alternative embodiments may also be implemented in software or code residing and executing in the hardware controller 201 or a processor. Two non-PCI bus peripheral I/O devices, Device 0 210 and Device 1 220, are shown in this example, although the hardware controller 201 of this embodiment is capable of supporting three individual non-PCI devices. The non-PCI bus devices 210, 220, are coupled to the hardware controller 201 on a non-PCI compatible bus 212. The systems of other embodiments can be designed to handle a different number of non-PCI devices. In this embodiment, the non-PCI bus 212 is configured to be shared with multiple devices as a flat bus hierarchy and more than one non-PCI device can be physically connected to the bus 212.

A system interrupt controller 230 is coupled to the hardware controller 201. Three separate interrupt request (IRQ) lines 234, 236, 238, one for each of the supported I/O devices, extend between the interrupt controller 230 and the hardware controller 201. For this embodiment, the interrupt lines are handled by the hardware controller 201 and do not physically connect to the non-PCI devices. However, the interrupt lines of other embodiments may be coupled to the non-PCI devices. The hardware controller 201 includes interrupt resources to handle the PCI Interrupt Pin and Interrupt Line registers for each non-PCI I/O device. In this embodiment, bits in a read-only PCI Interrupt Pin register is set for each device that uses interrupts. During the I/O device discovery and configuration process, the configuration algorithm for each device writes the interrupt routing information to PCI Interrupt Line register for each device. The system interfaces the hardware controller 201 and the attached non-PCI devices 210, 220, through an I/O device driver 240. The I/O device driver 240 may comprise of one or more software components that may or may not be part of the operating system. For this embodiment, the I/O bus driver 240 is the PCI.SYS driver found in Microsoft Windows. Specific software device drivers 244, 246, 248, for each of the non-PCI bus devices that are installed interface to the I/O bus driver software 240 for enumeration and configuration for each of the non-PCI devices.

The system also provides memory resources as a memory mapped region in the system memory for each of the I/O devices coupled to the hardware controller 201. The PCI memory base address register for each non-PCI device is implemented in this embodiment of the hardware controller 201 to cause the configuration software to allocate a 4 kilobyte (KB) memory mapped I/O region for each of the non-PCI devices. These memory regions 224, 226, 228, are to support the device control and data pipes. During the discovery and configuration process, the configuration software for each I/O device allocates the 4 KB memory mapped region and writes the memory start address to the PCI memory base address register for that device. The memory mapped regions 224, 226, 228, also interface with the I/O device driver 244, 246, 248, for the respective non-PCI I/O device. The hardware controller 201 of this embodiment also includes a direct memory access (DMA) controller for each I/O device to handle the accesses to the associated memory space. Both the system and a non-PCI peripheral device can read and write to the memory mapped space for that particular I/O device. During normal operations, data can be communicated back and forth between the processor and a non-PCI device as each uses the assigned memory space as a storage buffer and transfer mechanism.

Also coupled to the hardware controller 201 are registers or memory spaces for the configuration of each of the non-PCI devices that can be attached to the non-PCI bus 212 and also for the hardware controller 201 itself. These configuration (config) spaces 211, 214, 216, 218, are used with the PCI bus 213 and the PCI device driver to ensure proper device recognition and operation. The hardware controller 201 of this embodiment is responsible for mapping the configuration information for downstream non-PCI devices appropriately into the PCI configuration space associated with each non-PCI device. The PCI configuration spaces 214, 216, 218, can store the PCI related configuration information for each of the associated I/O devices. For instance, the Device 0 PCI configuration space 214 can store the vendor ID (VID), device ID (DID), memory mapped addresses, interrupts, etc. for Device 0 210. Similarly, the bridge PCI configuration space 211 is used to configure the hardware controller (bus bridge) 201 for use on the PCI bus 213. The bridge PCI configuration space 211 is to store the vendor ID (VID), device ID (DID), memory mapped addresses, interrupts, etc. for bus bridge 201. The hardware controller 201 needs the bridge PCI configuration space 211 because the PCI system views the hardware controller 201 as a P2P bridge on the PCI bus 212. The hardware controller 201 manages a PCI configuration Header Type 1 as required for P2P bridges under the PCI bus protocol. A PCI configuration Header Type 0 is also managed by the hardware controller 201 for each of the possible three downstream non-PCI CFE devices of this embodiment. Each PCI configuration Header Type 0 in this embodiment implements a 16-bit status word to facilitate error recovery by the device driver. The hardware controller 201 of this embodiment can support the standard PCI configuration fields needed for proper operation and PCI functionality. The PCI configuration spaces 211, 214, 216, 218, also interface with the I/O bus driver 240.

The hardware controller 201 allows the non-PCI I/O devices to be treated as normal PCI devices from the viewpoint of the system. The non-PCI bus architecture and its related devices, are transparent to the system. Embodiments in accordance with the present invention allow for new buses and buses with a non-PCI topology to be backwards compatible with legacy systems that cannot be upgraded. Similarly the PCI drivers are not aware of non-PCI devices being coupled to the PCI bus. The non-PCI architecture can thus make use of the available built-in support in the operating system for the PCI architecture. Althought the hardware controller (bus bridge) 201 described in these examples are separate components, the functionality of the hardware controller may be incorporated into the chipset of alternative embodiments.

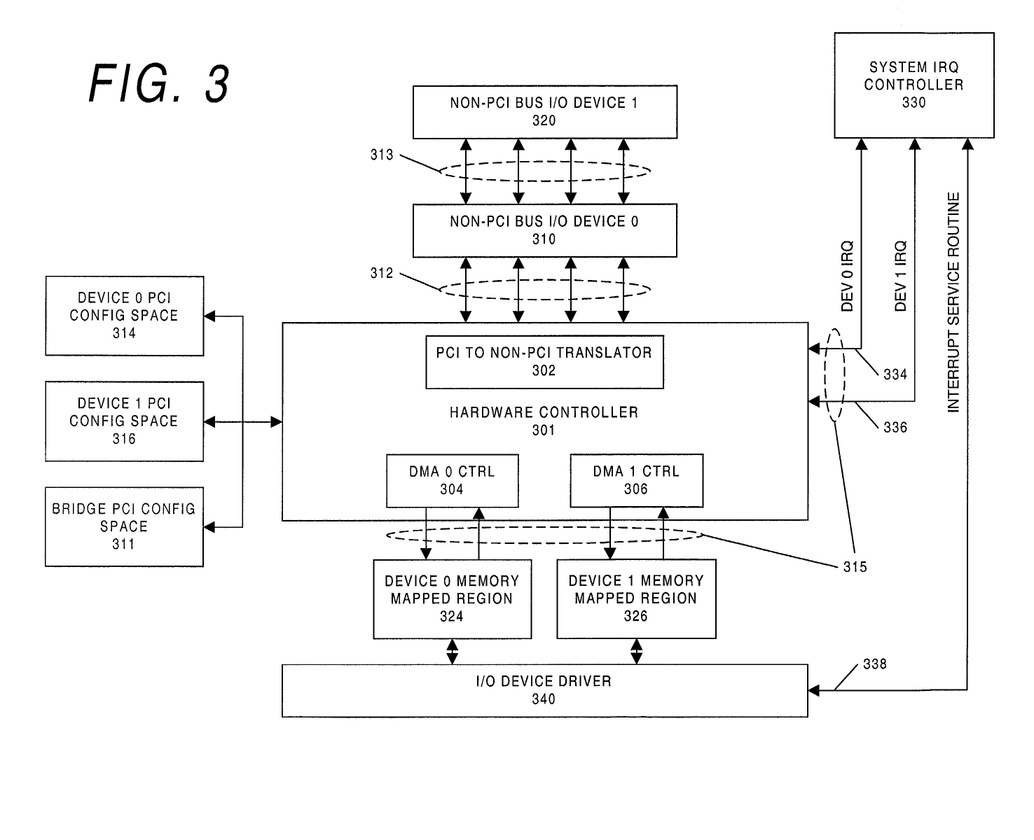

FIG. 3 is a block diagram of another embodiment of a non-PCI compatible bus architecture joined with a PCI compatible bus architecture. The hardware controller (PCI to non-PCI bus bridge) 301 of this embodiment physically resides on the system motherboard, but may also be mounted on a plug-in board or expansion card that slides into a PCI slot on the motherboard. A PCI to non-PCI translator 302 is included in the hardware controller 301. This translator 302 is to translate data, commands, interrupts, and other information between the PCI and non-PCI bus protocols. The present embodiment is configured to operate with a daisy chain of non-PCI bus devices connected to one another in series. Two non-PCI bus peripheral I/O devices, Device 0 310 and Device 1 320, are shown coupled together in a daisy-chain pattern in this example. Depending on the particular implementation, the system and hardware controller 301 may be capable of supporting one or more individual non-PCI devices. A first non-PCI bus device, Device 0 310, is coupled to the hardware controller 301 on a non-PCI compatible bus 312. A second non-PCI bus device, Device 1 320, is coupled to Device 0 310 on a non-PCI compatible bus 313. The non-PCI buses 312, 313, are of the same non-PCI bus protocol type. If there are no I/O devices connected to the hardware controller 301, the bus bridge 301 simply appears as another device on the PCI bus 315 from the viewpoint of the operating system.

A system interrupt controller 330 is coupled to the hardware controller 301. Two separate interrupt request (IRQ) lines, Device 0 IRQ 334 and Device 1 IRQ 336, one for each of the supported I/O devices shown in FIG. 3, extend between the interrupt controller 330 and the hardware controller 301. Additional IRQ lines may be added as needed if additional I/O devices are coupled to the hardware controller 301. The system interfaces the hardware controller 301 and the attached non-PCI devices 310, 320, through an I/O device driver 340. Within the I/O device driver software 340 can be the specific software device drivers for each of the non-PCI bus devices 310, 320, that are installed. The system provides a memory mapped region 324, 326, in the system memory for each of the I/O devices 310, 320, coupled to the hardware controller 301. The hardware controller 301 of this embodiment also includes a DMA controller for each I/O device to handle the accesses to the associated memory space. Both the system and a non-PCI peripheral device can read and write to the memory mapped space for that particular I/O device.

Also coupled to the hardware controller 301 are registers or memory spaces for the configuration of each of the non-PCI devices that can be attached via a non-PCI bus 312, 313, and also for the hardware controller 301 itself. These configuration spaces 311, 314, 316, are used with the PCI bus 313 and the PCI device driver to ensure proper device recognition and operation. The PCI configuration spaces 311, 314, 316, can store the PCI related configuration information for each of the associated hardware. The configuration space can store the PCI vendor ID (VID), PCI device ID (DID), memory mapped addresses, interrupts, etc. As described in regards to IRQ lines above, resources such as memory mapped regions, DMA control, and/or configuration space may be added or brought online as needed if additional I/O devices are coupled to the hardware controller 301, and removed or sent offline if non-PCI I/O devices are removed from the system.

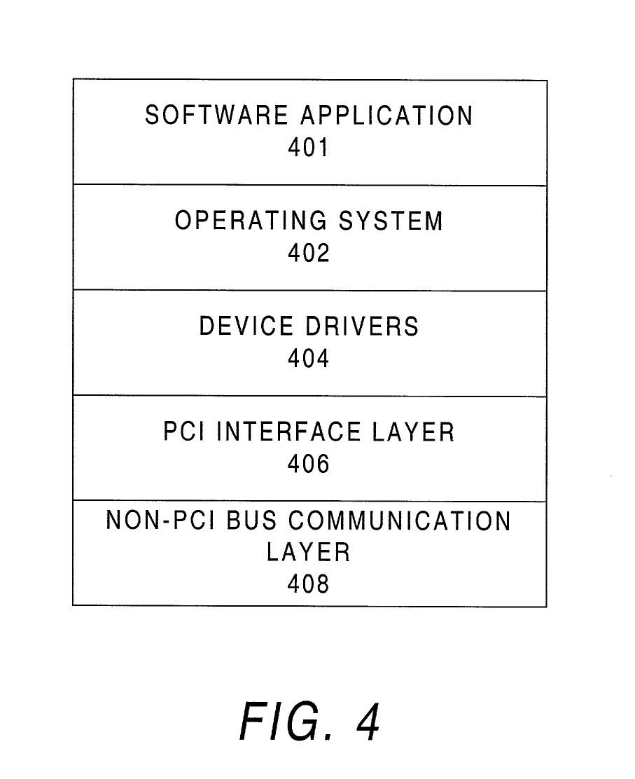

FIG. 4 is a block diagram of the software stack residing in a computer of one embodiment. The software stack shown in FIG. 4 comprises of application software 401, an operating system 402, software device drivers 404, a PCI interface layer 406, and a non-PCI bus communication layer 408. For one embodiment, the upper level of the software stack in the computer is the operating system 402, such as a version of Microsoft Windows. The operating system 402 is generally the software interface between users and the system hardware. A user can input commands and data to the control software application 401, which in turn directs the inputs to the appropriate portions of the operating system 402. The next layer of software in the stack comprises of software device drivers 404. Device drivers 404 handle the software commands and instructions from the operating system 402 and issues the related control signals and data to hardware devices or controllers. In some systems, the device driver for a given device is loaded when the device itself is detected by the system. Detection of a PCI type device often occurs during system startup. However, detection of I/O devices can be performed dynamically as in plug-and-play computers. Device drivers are often provided by hardware manufacturers and are specific to a particular hardware device. However, generic device drivers may also be available for devices such as keyboards and mice. These device drivers 404 can also be part of the operating system 402.

In the software stack of this embodiment, a PCI interface layer 406 exists between the software device drivers 404 and the non-PCI bus communication layer 408. This PCI interface layer 406 enables the software device drivers 404 to communicate with devices across a PCI bus. The PCI interface layer of this embodiment is the PCI.SYS driver of Microsoft Windows. For a typical computer where I/O devices are connected to a PCI bus, the device drivers 404 communicate with the devices through circuitry, logic, and cables. Depending on the implementation, the non-PCI bus communication layer 408 can comprise of mostly software or hardware components or a mix of both. The non-PCI bus communication layer 408 manages the communications between the system and non-PCI bus compatible I/O devices. The non-PCI bus communication layer 408 provides an interface between a PCI bus architecture and a non-PCI compatible bus architecture.

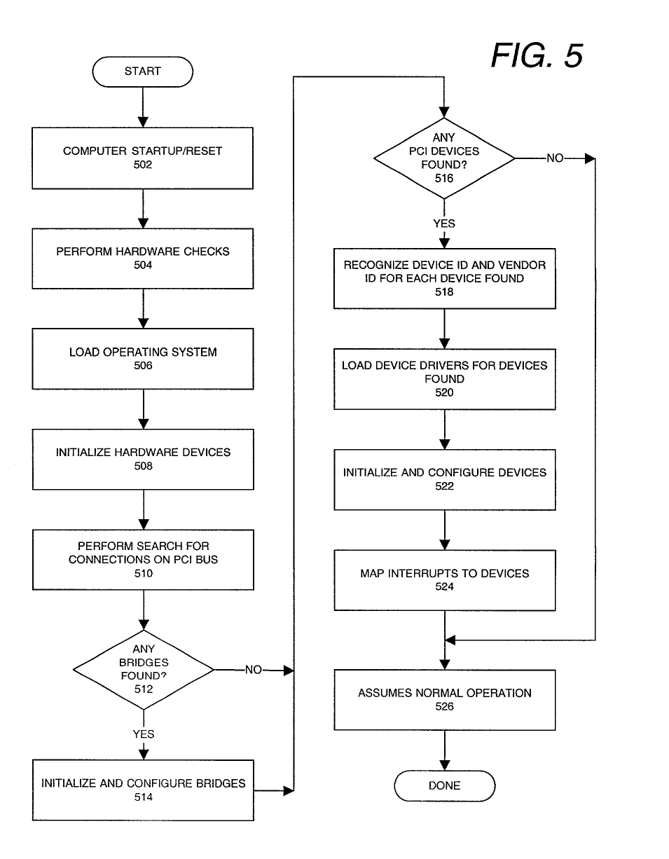

FIG. 5 is a flow chart showing one embodiment of a method to initialize a computer to access a non-PCI compatible bus architecture in accordance with the present invention. This example generally describes the initialization operation of a PCI bus and its connected devices in one embodiment during a system startup or reset. At block 502, the computer emerges from a system startup or reset sequence. The computer performs a hardware check of basic onboard components and devices at 504. This hardware check can entail a query to determine what components and devices are physically present in the computer and whether they are operational. For this embodiment, these onboard components and devices can include items physically connected to the motherboard. The operating system is loaded at block 506. At block 508, the hardware devices found during the hardware checks of block 504 are initialized and configured for use.

The computer performs a search for connections on the PCI bus at block 510. The PCI controller goes through an enumeration and discovery process. PCI compliant connections are found and recognized. PCI devices need to be mapped into the PCI configuration space so that the devices can be found by the system in the BIOS. Furthermore, the PCI devices have to be identified to cause the related drivers to be loaded. At block 512, the computer checks whether any bus bridges were found. If no bus bridges are found at block 512, then any device using this PCI bus should be directly connected to this bus. A bus bridge may also provide the computer with its device ID and vendor ID so that the operating system can recognize the component and load a device driver for the bridge. This computer can go on to search for PCI type of devices at block 516. PCI devices attached to the PCI bus have PCI device class identifiers. But if any bridges are found on the PCI bus at block 512, then this computer initializes and configures the discovered bus bridges at block 514. A check for PCI type for PCI type of devices is made at block 516. If no PCI devices are found at block 516, the system is done configuring the PCI bus. The computer completes the system startup procedure and assumes normal operation at 526.

If any PCI type of devices are found at block 516, the computer proceeds to set up these devices. At block 518, the PCI system driver receives and recognizes the device ID and the vendor ID for each of the devices found. Based on the device ID and the vendor ID, the system can load the appropriate device driver for specified device at block 520. Device drivers are loaded for each of the devices so that the devices can operate properly with the system. At block 522, the hardware for the PCI devices is initialized and configured. Once these I/O devices are configured, the computer can control and communicate with the devices. The operating system maps any interrupts needed to the devices at block 524. These interrupts can be used by the system to request service from a PCI type device and by a device on the PCI bus to request service from the system. When all the devices on the PCI bus are recognized and configured, the computer proceeds on towards normal operations at block 526.

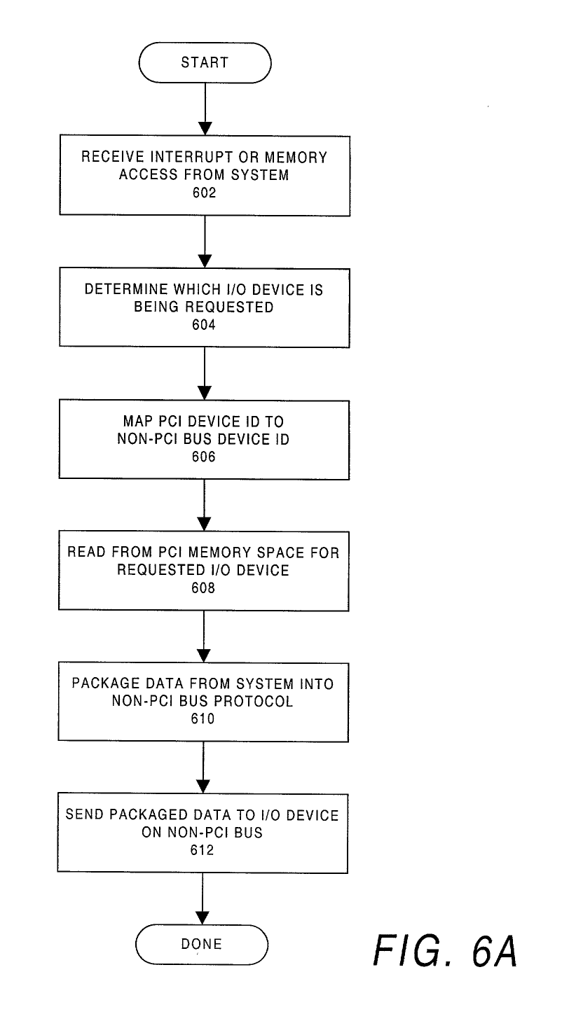

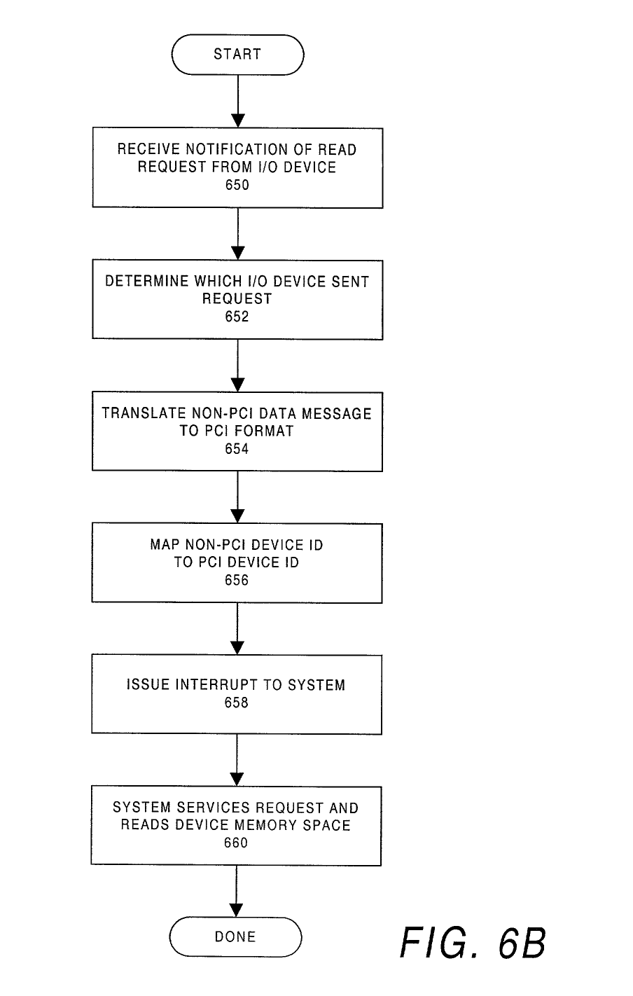

FIG. 6A is a flow chart showing one embodiment of a method in accordance with the present invention to communicate with a non-PCI compatible device across a PCI bus. The method of this example describes what occurs during an access from the system to a non-PCI compatible device that is coupled to the system PCI bus through a bus bridge. For this embodiment, one end of the bus bridge connects to the system PCI bus and the other end of the bus bridge connects to a non-PCI compatible bus. The non-PCI compatible bus of this example is not specified, but the non-PCI compatible bus can be one of many types of bus protocols available, depending on the embodiment.

Whenever the system needs to communicate with the non-PCI I/O device, an interrupt or a memory access request is made from the operating system through the associated device driver to the I/O device. These interrupts and requests are first routed to a bus bridge. For this embodiment, the bus bridge is a hardware controller to handle the communications between the PCI protocol and a non-PCI protocol. At block 602, the controller receives an interrupt signal or a memory access request from the system. At block 604, the controller determines which of the attached I/O devices is being requested. This determination can yield a PCI device ID that indicates which device the system is referencing. For one embodiment, this determination can be made based on which particular interrupt is asserted. Similarly, the memory access request can include a specific memory address where the system has written data for the I/O device. In an embodiment using memory mapped I/O, a given memory address range is mapped and reserved to a specific I/O device. At block 606, the controller maps the PCI device ID to the appropriate non-PCI bus device ID. Whereas the PCI device ID is the name for the I/O device on the system or PCI side of the controller, this non-PCI bus device ID is name for the same device on the non-PCI compatible side of the controller. For another embodiment, a different type of label or marker may be used to refer to an I/O device and a device ID may not exist.

At block 608, the controller reads from the PCI memory space mapped for the requested I/O device. The system has written data for the device at that memory region. The controller takes the data and packages the data into the appropriate non-PCI bus protocol at block 610. The format, contents, and configuration of the packaged data is dependent on what type of non-PCI bus protocol is being applied in each particular embodiment. Once the data from the system is prepared, the packaged data is sent to the I/O device on a non-PCI compatible bus at block 612. Upon receiving the data, the device can read and respond to the data.

FIG. 6B is a flow chart showing one embodiment of a method in accordance with the present invention to receive communications from a non-PCI compatible device across a PCI bus. The method of this example describes what occurs during a communication from a non-PCI compatible device to the system across a PCI bus. Like the example of FIG. 6A, the communication occurs over a PCI to non-PCI bridge. For this embodiment, the data is traveling in the direction from the non-PCI device to the system.

Whenever a non-PCI I/O device needs to contact the system, the controller is notified. The controller (bus bridge) receives notification of a read request or an interrupt from an I/O device at block 650. The controller determines which I/O device sent the request at block 652 in order to able to service the request. Upon determining which device made the request, the controller translates the non-PCI data message from that device into a PCI format at block 654. The non-PCI ID for the device is also mapped to the PCI device ID that the system will recognize for this particular I/O device at block 656. The controller at block 658 issues an interrupt to the system on behalf of the device. This interrupt notifies the system that the I/O device requests service or has data for the system. At block 660, the system services the request and reads the memory mapped region for the device at the controller.

Although the above examples describes the coupling and communications between a non-PCI compatible bus architecture and a PCI bus architecture in the context of a hardware controller and logic, other embodiments of the present invention can be accomplished by way of software. Such software can be stored within a memory in the system. Similarly, the code can be distributed via a network or by way of other computer readable media. For instance, a computer program may be distributed through a computer readable medium such as a floppy disk or a CD ROM, or even a transmission over the Internet. Thus, a machine-readable medium can include any mechanism for storing or transmitting information in a form readable by a machine (e.g., a computer). For example, a machine-readable medium can include a read only memory (ROM), random access memory (RAM), magnetic disk storage media, optical storage media, flash memory devices, and electrical, optical, acoustical or other forms of propagated signals (e.g., carrier waves, infrared signals, digital signals, etc.).

In the foregoing specification, the invention has been described with reference to specific exemplary embodiments thereof. It will, however, be evident that various modifications and changes may be made thereof without departing from the broader spirit and scope of the invention as set forth in the appended claims. The specification and drawings are, accordingly, to be regarded in an illustrative rather than a restrictive sense.

What is claimed is:

1. A method comprising:
identifying a hardware controller coupled to a Peripheral Component Interconnect (PCI) compatible bus, said hardware controller compatible to a PCI bus protocol and to a non-PCI bus protocol;
initializing said hardware controller;
searching a non-PCI compatible bus coupled to said hardware controller for a non-PCI compatible device, said non-PCI compatible device compatible to said non-PCI bus protocol;
configuring said non-PCI compatible device; and
recognizing said non-PCI compatible device as a PCI compatible device coupled to said PCI compatible bus.

2. The method of claim 1 further comprising loading a PCI device driver for said hardware controller.

3. The method of claim 1 further comprising loading a software device driver for said non-PCI compatible device.

4. The method of claim 3 wherein said configuring further comprises routing an interrupt for said non-PCI compatible device to circuitry in said hardware controller.

5. The method of claim 4 wherein said configuring further comprises allocating a memory resource for said non-PCI compatible device.

6. The method of claim 5 further comprising setting up said memory resource as a memory mapped input/output (I/O) region to be accessible by said software device driver and said hardware controller.

7. The method of claim 6 wherein said configuring further comprises loading and storing a vendor identifier, a device identifier, and a PCI configuration Header Type 0 for said non-PCI compatible device in a first configuration space in said hardware controller.

8. The method of claim 7 wherein said initializing further comprises loading and storing a vendor identifier, a device identifier, and a PCI configuration Header Type 1 for said hardware controller in a second configuration space in said hardware controller.

9. The method of claim 8 further comprising initializing said non-PCI compatible bus.

10. A method comprising:
receiving a request on a Peripheral Component Interconnect (PCI) bus;
identifying a non-PCI compatible device designated by said request;
reading a memory space for data designated for said non-PCI compatible device;
translating said data from a PCI compatible format into a data package having a non-PCI compatible format; and
sending said data package on a non-PCI compatible bus to said non-PCI compatible device.

11. The method of claim 10 further comprising mapping a PCI device identifier for said request to a non-PCI device identifier.

12. The method of claim 11 wherein said reading comprises making a direct memory access to said memory space.

13. The method of claim 12 wherein said request comprises a device interrupt.

14. A method comprising:
receiving a request on a non-Peripheral Component Interconnect (PCI) bus;
identifying a non-PCI compatible device that sent said request;
translating data from said non-PCI compatible device into a data package having a PCI compatible format;
writing said data package over a PCI bus into a memory space designated for said non-PCI compatible device; and
issuing an interrupt on said PCI bus to a software device driver.

15. The method of claim 14 further comprising said software device driver accessing said data package from said memory space.

16. The method of claim 15 further comprising mapping a non-PCI device identifier for said request to a PCI device identifier.

17. The method of claim 16 wherein said writing comprises making a direct memory access to said memory space.

18. An apparatus comprising:
an first bus interface circuit to connect to a Peripheral Component Interconnect (PCI) compatible bus, said first bus interface circuit to communicate a first data packet over said PCI compatible bus;
translator logic coupled to said interface circuit, said translator logic to translate said first data packet from a PCI compatible format to a second data packet having a non-PCI compatible format; and
a second bus interface circuit to connect to a non-PCI compatible bus, said second bus interface circuit to communicate said second data packet over said non-PCI compatible bus.

19. The apparatus of claim 18 further comprising an interrupt handler to receive an interrupt from a system interrupt controller.

20. The apparatus of claim 19 further comprising a first configuration space to store a vendor identifier, a device identifier, and a PCI configuration Header Type 1 for said apparatus.

21. The apparatus of claim 20 further comprising a second configuration space to store a vendor identifier, a device identifier, and a PCI configuration Header Type 0 for a non-PCI compatible device.

22. The apparatus of claim 21 wherein said non-PCI compatible device is coupled to said non-PCI compatible bus.

23. The apparatus of claim 22 further comprising a direct memory access controller to perform direct memory accesses to a memory region in a memory device external to said apparatus.

24. A system comprising:
a processor to execute program instructions;
a memory coupled to said processor, said memory to store said program instructions and data;
a Peripheral Component Interconnect (PCI) bus coupled to said memory and said processor;
a non-PCI compatible bus; and
a hardware controller coupled to said PCI bus and to said non-PCI compatible bus, said hardware controller comprising:
an first bus interface circuit to connect to said PCI bus, said first bus interface circuit to communicate a first data packet over said PCI bus;
translator logic coupled to said interface circuit, said translator logic to translate said first data packet from a PCI compatible format to a second data packet having a non-PCI compatible format; and
a second bus interface circuit to connect to said non-PCI compatible bus, said second bus interface circuit to communicate said second data packet over said non-PCI compatible bus.

25. The system of claim 24 wherein said hardware controller is to bridge together said PCI bus and said non-PCI compatible bus, said hardware controller to mask incompatibilities between said PCI bus and said non-PCI compatible bus, wherein a non-PCI type device coupled to said non-PCI compatible bus can communicate to said processor over said PCI bus.

26. The system of claim 25 wherein said hardware controller further comprises an interrupt handler to receive an interrupt from a system interrupt controller.

27. The system of claim 26 wherein said hardware controller further comprises a first configuration space to store a vendor identifier, a device identifier, and a PCI configuration Header Type 1 for said hardware controller.

28. The system of claim 27 wherein said hardware controller further comprises a second configuration space to store a vendor identifier, a device identifier, and a PCI configuration Header Type 0 for said non-PCI type device.

29. The system of claim 28 wherein said hardware controller further comprises a direct memory access controller to perform direct memory accesses on said PCI bus to a memory region in said memory.
